(19) United States
(12) Patent Application Publication
(10) Pub. No.: US 2007/0137353 A1
(43) Pub. Date: Jun. 21, 2007

(54) Torque limitation device in retarding mechanism

(76) Inventor: Tso-Wen Chu, Fongyuan City (TW)

Correspondence Address: TSO-WEN CHU, P.O. Box 697, Taichung County, Fongyuan City, 420, R.O.C., TW

(21) Appl. No.: 11/288,184

(22) Filed: Nov. 29, 2005

(51) Int. Cl. F16H 1/16

(52) U.S. Cl. 74/425

(57) ABSTRACT

A torque limitation device in a retarding mechanism includes a worm shaft engaged with a worm gear in a gear case and operated by a motor. The worm gear is pressed by an elastic adjustment assembly and indirectly rotates a transmission shaft which actuates the entire machine to work. When the transmission shaft is obstructed or in a rough rotation to cause an torque increasing, the worm shaft and the worm gear are immediately begin an idle running and the worm gear become slippery with the transmission shaft so as to prevent the motor from damaged for overloading.

### BACKGROUND OF THE INVENTION

The present invention relates to retarding mechanism and more particularly to a torque limitation device in retarding mechanism for protecting the motor from damaged for overloading.

As we know that a turbine retarding mechanism adopts to a conveyer, an elevator, a crane, the transportation mechanisms, a mixer, a swivel working table, a robot and varied machinery. These machinery should have a retarding mechanism between the motor and other devices. Therefore, the turbine retarding mechanism is extensively used in the mechanical engineering. For a running motor will be overloaded because of the rough rotation of the output shaft that causes the damage of the motor to reduce the life of the machine.

FIG. 1 shows a prior art turbine retarding mechanism which comprises a worm shaft 1 (input shaft) operated by a motor and actuating a turbine 2 to rotate. The turbine 2 is in turn to rotate a transmission shaft 3 (output shaft). When the transmission shaft 3 is rotated not so smoothly or obstructed, it will cause the motor overloaded or even damaged that the whole machine shall breakdown and cost more to repair.

### SUMMARY OF THE PRESENT INVENTION

The present invention has a main object to provide a torque limitation device in retarding mechanism. When the torque of the transmission shaft (output shaft) becomes larger than the torque of the worm gear which is a limited by an elastic adjustment assembly, the worm shaft together with the worm gear will be idle running to prevent the motor from damaged for burning, so as to reduce the cost of repairmen.

Accordingly, the torque limitation device in retarding mechanism of the present invention comprises generally a worm shaft which is operated by motor and a worm gear which is operated by the worm shaft and indirectly operates a transmission shaft. The character is that the worm gear is pressed by an elastic adjustment mechanism. When the torque of the transmission shaft becomes larger than the torque of the worm gear that decided by the elastic adjustment mechanism so that the elastic adjustment mechanism and the worm gear become slippery causing the worm shaft together with the worm gear becoming idle running in order to prevent the motor from damaged for overloading.

The present invention will become more fully understood by reference to the following detailed description thereof when read in conjunction with the attached drawings.

### BRIEF DESCRIPTION OF THE DRAWINGS

FIG. 1 is a sectional view to show a transmission mechanism of worm gear retarding device according to a prior art,

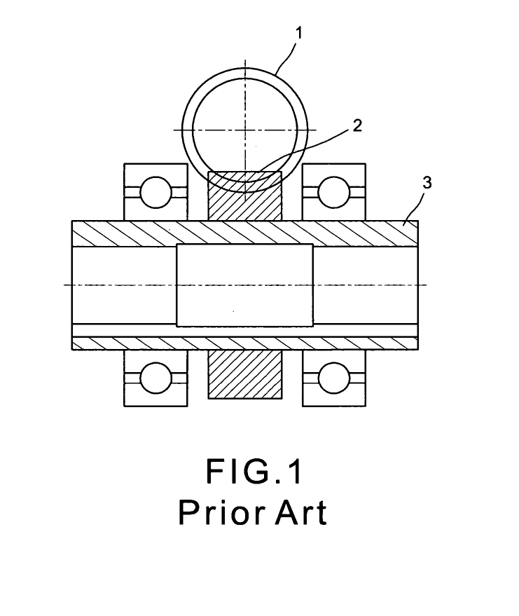

FIG. 2 is a section view to show a transmission mechanism of the retarding device according to the present invention,

FIG. 3 is a sectional view to show the rollers, worm gear and a pressure live plate, and

FIG. 4 is a plane view to show the positions of the worm shaft, gear case and other elements.

### DETAILED DESCRIPTION OF THE PREFERRED EMBODIMENT

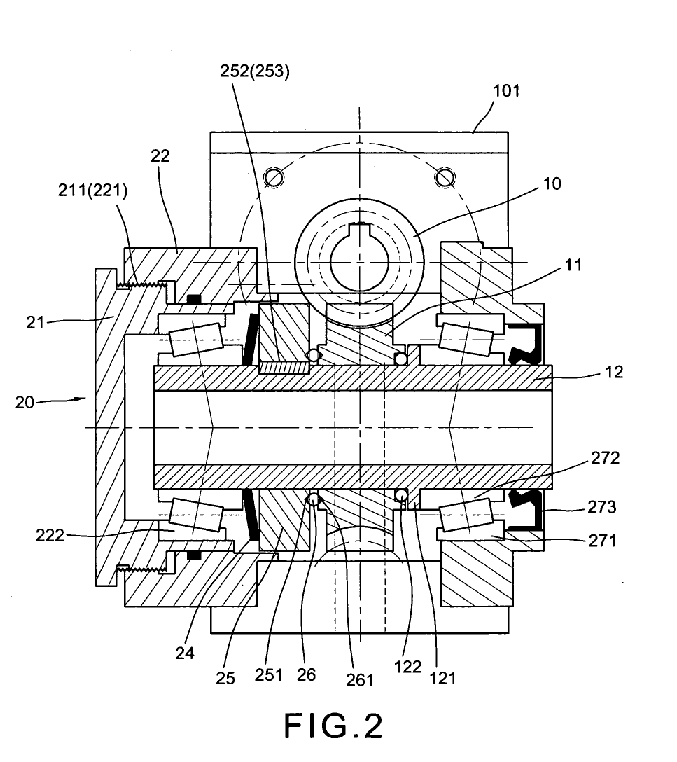

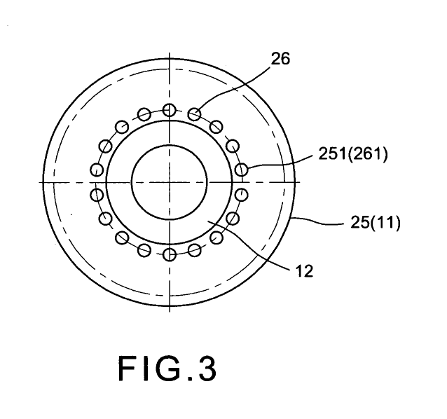

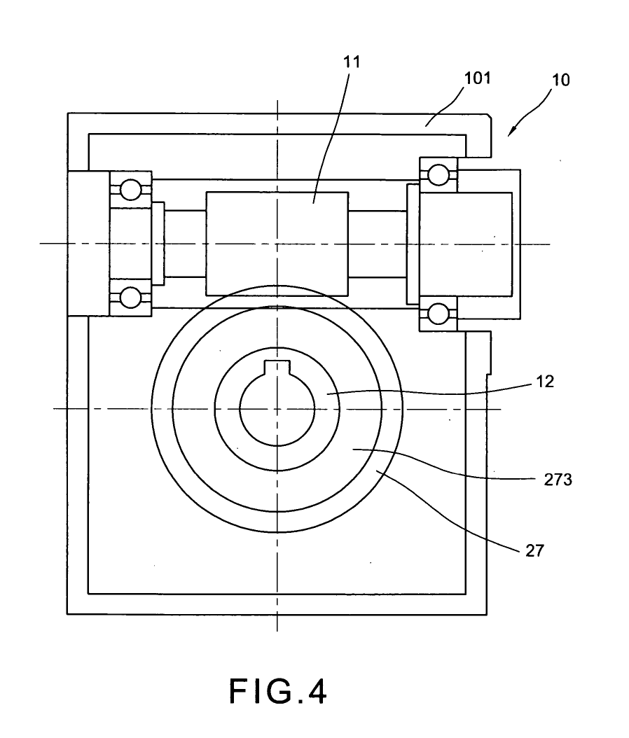

With reference to FIGS. 2, 3 and 4 of the drawings, the torque limitation device in retarding mechanism of the present invention comprises a worm shaft 10 engaged with a worm gear 11 on a lateral side of a transmission shaft 12 and operated by a motor (not shown) in a gear case 101, an elastic adjustment assembly 20 pressing the worm gear 11 and indirectly rotating the transmission shaft 12 to operate the whole machine. The elastic adjustment assembly 20 is positioned at one end of the transmission shaft 12 and includes a roughly U-shaped pressure adjustment cap 21 engaged with a bearing case 22 through their threads 211 and 221 so that the pressure adjustment cap 21 is adjustable, a pushing collar 23 between the pressure adjustment cap 21 and the transmission shaft 12, an elastic member 24 abutting a pressure live plate 25 closed to the worm gear 11. The pressure adjustment cap 21 is slidably in the bearing case 22 to push the pushing collar 23, the elastic member 24 and the pressure live plate 25. The bearing case 22 has a bearing 222 therein to wrap the pushing collar 23. The pressure live plate 25 is engaged with the transmission shaft via a slot 252 and a shaft key 253 and has a plurality of slots 251 spacedly aligned a circular shaped and facing the similar slots 261 in the relative side of the worm gear 11 for positioning a plurality of rollers 26 which are substantially the steel balls. The other side of the worm gear 11 engages with an annular collar 121 of the transmission shaft 12 with a thrust bearing 122 engaged therebetween. On the other side of the worm gear 11, there is a non-thread bearing case 27 (as shown in FIG. 4) inside of which is a bearing 271, a pushing collar 272 and an oil seal 273, wherein the pushing collar 272 stops against the annular collar 121 of the transmission shaft.

Upon the aforediscussed arrangement, the pressure live plate 25 through the rollers 26 actuated by the worm gear 11 to rotate the transmission shaft to operate the entire machine to work. When the transmission shaft 12 is obstructed or rotated abnormally and needs the torque larger than the torque of the worm gear 11 given by the elastic adjustment assembly 20. The engagement of the pressure live plate 25 with the worm gear 11 will break off so as the rollers 26 disengage with the slots 251 and 261. Therefore, the worm gear 11 and the pressure live plate 25 become slippery causing the worm shaft 10 and the worm gear 11 begin to idle running to prevent the motor from damaged for overloading. The torque force is decided by rotating the pressure adjustment cap 21 forward or backward to intensity or release the pressure against the pushing collar 23, the elastic member 24 and the pressure live plate 25. The decided torque force is normally smaller than that of the transmission shaft 12 (output shaft). It aims to cause an idle running of the worm shaft 10 to protect the motor from burning for overloading. Otherwise, to elongate the life of the machine.

Note that the specification relating to the above embodiment should be construed as an exemplary rather than as a limitative of the present invention, with many variations and modifications being readily attainable by a person of average skill in the art without departing from the spirit or scope thereof as defined by the appended claims and their legal equivalents.

I claim:

1. A torque limitation device in retarding mechanism comprising:
a gear case containing a worm shaft engaged with a worm gear on a lateral side of a transmission shaft which engages with said worm gear;
an elastic adjustment assembly on one end of said transmission shaft and comprising a U-shaped pressure adjustment cap which has outer threads slidably engaged with corresponding inner threads of a bearing case which includes a first bearing wrapped a first pushing collar positioned between said pressure adjustment cap and said transmission shaft and engaged with an elastic member and a pressure live plate which engages said transmission shaft via a slot and a shaft key, said pressure live plate having a plurality of slots in inner surface and spacedly aligned into a circular shaped and facing corresponding slots in outer side of said worm gear for respectively engaging a plurality of rollers therein, said worm gear having an inner side engaged with an annular collar of said transmission shaft with a thrust bearing positioned therebetween;
a non-threads bearing case on other end of said transmission shaft opposite to said elastic adjustment assembly and including a second bearing, a second pushing collar and an oil seal therein wherein said second pushing collar stopping against and the annular collar of said transmission shaft;
whereby, said elastic adjustment assembly decides a torque force smaller than that of said transmission shaft to prevent said motor from damaged for overloading.
